(19) United States
(12) Patent Application Publication
(10) Pub. No.: US 2010/0181886 A1
(43) Pub. Date: Jul. 22, 2010

(54) Heat dissipating module

(76) Inventors: Nien-Hui Hsu, Hukou Township (TW); Shang-Hsuang Wu, Hukou Township (TW); Chih-Cheng Chou, Hukou Township (TW)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/654,812

(22) Filed: Jan. 5, 2010

(30) Foreign Application Priority Data
Jan. 21, 2009 (TW) 098102321

(51) Int. Cl. H01J 7/24; G06F 1/20; F28D 15/00

(52) U.S. Cl. 313/45; 165/121

(57) ABSTRACT

A heat dissipating module is adapted for transferring heat from a heat source. The heat dissipating module includes a first heat sink, a fan, a second heat sink, and a partition. The first heat sink is adapted to be connected to the heat source and has an outlet. The fan is disposed adjacently to the first heat sink. The second heat sink is connected to the first heat sink. The partition is disposed between the first heat sink and the second heat sink and has an inlet, and the position of the inlet is corresponding to the position of the fan. An airflow driven by the fan is capable of flowing through the second heat sink, the inlet, and the first heat sink in sequence, and the airflow is capable of exiting from the outlet of the first heat sink.

### CROSS REFERENCE TO RELATED APPLICATION

This application claims the priority benefit of Taiwan application serial no. 98102321, filed on Jan. 21, 2009. The entirety of the above-mentioned patent application is hereby incorporated by reference herein and made a part of this specification.

### BACKGROUND OF THE INVENTION

1. Field of the Invention

The invention relates to a heat dissipating module and an illuminance device, and more particularly to a heat dissipating module and an illuminance device disposed on a heat source for transferring heat from the heat source.

2. Description of Related Art

Since the technology is developed by leaps and bounds in recent years, an operation of electronic component is more and more high performance, and a heating power of the electronic component is more and more raise. In order to prevent overheating of the electronic component and lead to a temporary or permanent failure, it becomes important to provide enough cooling performance.

In order to effectively reduce heat of the electronic component produced by the operation of the electronic component, the electronic component that the temperature is easily raise may be install a heat dissipating module to remove heat of the electronic component produced by the operation of the electronic component. In the conventional technology, method for dissipating heat includes a natural convection and a forced convection.

The heat dissipating module using the natural convection may have a bulky heat sink to provide an enough cooling performance. However, the volume and the weight of the heat dissipating module are larger, and thus lead to a higher cost. The heat dissipating module using the forced convection may have an additional fan and the fan occupies an additional volume.

When the heat dissipating module uses an axial fan, a specific region may be difficult to dissipate heat and the cooling performance may be not excellent. When the heat dissipating module uses a centrifugal fan, the air quantity of heat dissipating module is relatively weak and the cooling performance is not excellent.

### SUMMARY OF THE INVENTION

Accordingly, the invention is directed to a heat dissipating module, wherein the heat dissipating module is disposed on a heat source and capable of providing good heat dissipation efficiency for the heat source.

The invention is also directed to an illuminance device having a heat dissipating module capable of providing good heat dissipation efficiency for the heat source.

An embodiment of the invention provides a heat dissipating module adapted for transferring heat from a heat source. The heat dissipating module includes a first heat sink, a fan, a second heat sink, and a partition. The first heat sink is adapted to be connected to the heat source and has an outlet. The fan is disposed adjacently to the first heat sink. The second heat sink is connected to the first heat sink. The partition is disposed between the first heat sink and the second heat sink and has an inlet, and the position of the inlet is corresponding to the position of the fan. An airflow driven by the fan is capable of flowing through the second heat sink, the inlet, and the first heat sink in sequence, and the airflow is capable of exiting from the outlet of the first heat sink.

In an embodiment of the invention, a flow direction of the airflow driven by the fan in the second sink and a flow direction of the airflow driven by the fan in the first sink are adverse.

In an embodiment of the invention, the second heat sink is connected to the first heat sink through the partition, and a material of the partition includes a thermal conduction material, such as metal.

In an embodiment of the invention, the first heat sink and second heat sink are integrally formed. A gap between the first heat sink and second heat sink is divided by the partition, and the material of the partition includes an heat insulation material, such as plastic.

In an embodiment of the invention, the fan is a centrifugal fan.

In an embodiment of the invention, the heat dissipating module further includes an outlet guiding component adjoining the outlet for changing a flow direction of the airflow exiting from the outlet.

In an embodiment of the invention, the heat dissipating module further includes a guiding housing disposed on one side of the second heat sink, so as to make the second heat sink be disposed between the guiding housing and the partition. The guiding housing, the second heat sink, and partition form a channel area, and the channel area is communicated with the inlet.

In an embodiment of the invention, the heat source is a light emitting diode.

In an embodiment of the invention, the first heat sink includes a heat dissipating base and a plurality of heat sink fins, and the heat dissipating base has a first surface and a second surface opposite to the first surface. The first surface contacts the heat source. The heat sink fins and the fan are disposed on the second surface, so as to make the heat sink fins and the heat source be disposed at two opposite sides of the heat dissipating base respectively, and make the fan and the heat source be disposed at the two opposite sides of the heat dissipating base respectively.

In an embodiment of the invention, an orthogonal projection of the heat source on the second surface and an orthogonal projection of the fan on the second surface do not overlap.

In an embodiment of the invention, the heat source has a diffusion angle, so as to make an effective area of the heat source on the second surface be larger than the orthogonal projection of the heat source on the second surface. The effective area of the heat source and the orthogonal projection of the fan on the second surface do not overlap.

Another embodiment of the invention provides an illuminance device including a light source and the above-mentioned heat dissipating module.

In an embodiment of the invention, the illuminance device is a road lamp.

The embodiment or the embodiments of the invention may have at least one of the following advantages, the heat dissipating module employs multiple heat sinks and a partition to form channels and is capable of increasing heat exchange area and heat exchange time between the heat dissipating module and the airflow to improve the heat dissipation efficiency.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The embodiments of the invention may be better understood through the following description with reference to the accompanying drawings, in which:

FIG. 1 is a schematic structural view of a heat dissipating module according to a first embodiment of the invention.

FIG. 2 is a schematic structural view of a heat dissipating module according to a second embodiment of the invention.

FIG. 3 is a schematic structural view of a second surface of a heat dissipating base in FIG. 1.

FIG. 4 is a schematic structural view of a second surface of a heat dissipating base in FIG. 2.

FIG. 5 is a partial enlargement schematic structural view of a heat source, a heat dissipating base, a first heat sink, and a fan in FIG. 1.

FIG. 6 is a schematic structural view of a heat dissipating module according to a third embodiment of the invention.

### DETAILED DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “disposed” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

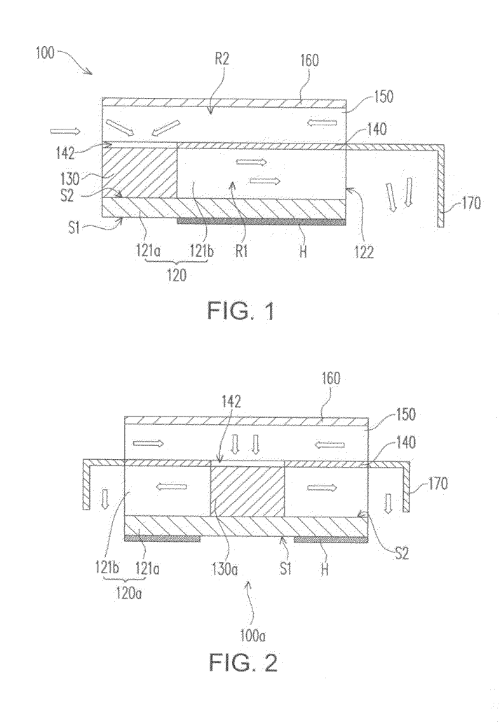

FIG. 1 is a schematic structural view of a heat dissipating module according to a first embodiment of the invention. Referring to FIG. 1, the heat dissipating module 100 is adapted for transferring heat from a heat source H such as a light emitting diode. In an embodiment of the invention, an illuminance device includes a light source and the heat dissipating module. In other embodiment of the invention, the illuminance device is a road lamp. The heat dissipating module 100 includes a first heat sink 120, a fan 130, a partition 140, and a second heat sink 150.

The first heat sink 120 is connected to the heat source H and has an outlet 122. The fan 130 is disposed adjacently to the first heat sink 120. The second heat sink 150 is connected to the first heat sink 120. The partition 140 is disposed between the first heat sink 120 and the second heat sink 150 and has an inlet 142, and the position of the inlet 142 is corresponding to the position of the fan 130.

Furthermore, in an embodiment of the invention, the second heat sink 150 is stacked above the first heat sink 120, a flow direction of the airflow driven by the fan 130 in the second sink 150 and a flow direction of the airflow driven by the fan 130 in the first sink 120 are adverse. The installation not only extends the airflow channel of the heat dissipating module 100, but shortens the volume of the heat dissipating module 100.

In this embodiment of the invention, the first heat sink 120 includes a heat dissipating base 120a and one set of interval arranged heat sink fins 121b, and the second heat sink 150 may be another set of interval arranged heat sink fins.

The airflow driven by the fan 130 is capable of flowing through the second heat sink 150, the inlet 142, and the first heat sink 120 in sequence, and the airflow is capable of exiting from the outlet 122 of the first heat sink 120. Therefore, the fan 130 is capable of carrying heat of the first heat sink 120 and the second heat sink 150 through the forced convection, so as to dissipate heat.

It should be noted, the airflow driven by the fan 130 flows through the second heat sink 150 and the first heat sink 120 in sequence, so as to increase heat exchange area and heat exchange time between the heat dissipating module 100 and the airflow to improve the heat dissipation efficiency.

In this embodiment of the invention, the second heat sink 150 is further connected to the first heat sink 120 through the partition 140, and a material of the partition 140 is a thermal conduction material, such as metal. In other embodiment of the invention, the partition 140 of thermal conduction material and the second heat sink 150 are integrally formed. Therefore, heat in the first heat sink 120 may be transmitted to the second heat sink 150 through the partition 140.

In this embodiment of the invention, the heat dissipating module 100 further includes a guiding housing 160 disposed on one side of the second heat sink 150, so as to make the second heat sink 150 be disposed between the guiding housing 160 and the partition 140. Therefore, a first channel R1 formed by the first heat sink 120 and the partition 140 is communicated with the inlet 142, the partition 140, the second heat sink 150, and the guiding housing 160 also form a second channel R2, and the second channel R2 is also communicated with the inlet 142.

The guiding housing 160 is capable of limiting the airflow flowing into the second heat sink 150 from the outside of the second heat sink 150, the airflow flows through the second channel R2, the inlet 142, and the first channel R1, and the airflow flows through the second heat sink 150 and the first heat sink 120 in sequence in a longer path to stay a longer time. Therefore, the heat exchange area and the heat exchange time between the second heat sink 150 and the airflow are increased to improve the heat dissipation efficiency.

In this embodiment of the invention, a material of the guiding housing 160 may be a thermal conduction material, and the guiding housing 160 may connect to the second heat sink 150. Heat of the second heat sink 150 may be transmitted to the guiding housing 160 to dissipate heat, and the heat dissipation efficiency is raised.

In this embodiment of the invention, the heat dissipating module 100 includes an outlet guiding component 170 adjoining the outlet 122 for changing a flow direction of the airflow exiting from the outlet 122. In specific, the airflow in the first heat sink 120 may change the flow direction through the outlet guiding component 170, the airflow exits towards the direction away from the first heat sink 150 to avoid the exited heat return to the heat dissipating module 100.

In below embodiments of the invention, a heat dissipating module 100a and a heat dissipating module 100b are the same as the heat dissipating module 100 in FIG. 1.

FIG. 2 is a schematic structural view of a heat dissipating module according to a second embodiment of the invention. Referring to FIGS. 1 and 2, in the first embodiment and the second embodiment, the fans 130 and 130a are centrifugal fans, and direction of the airflows is perpendicular to the axle of the fans 130 and 130a.

The heat dissipating module 100 in FIG. 1, the fan 130 is disposed on one side of the first heat sink 120, the airflow is inhaled from the inlet 142 above the fan 130 opposite to the axial of the fan 130 and flows to the first heat sink 120 from the fan 130 opposite to the axial of the fan 130.

However, the heat dissipating module 100a in FIG. 2, the fan 130a is disposed in the middle of the first heat sink 120a, the airflow is inhaled from the inlet 142 above the fan 130a opposite to the axial of the fan 130a and flows to the first heat sink 120a from the fan 130a opposite to the axial of the fan 130a.

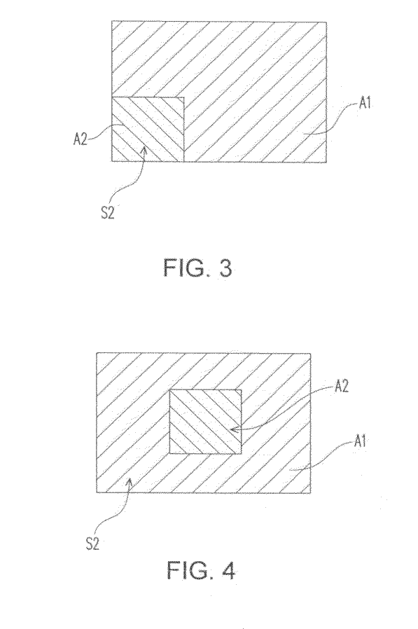

FIG. 3 is a schematic structural view of a second surface of a heat dissipating base in FIG. 1, and FIG. 4 is a schematic structural view of a second surface of a heat dissipating base in FIG. 2. Referring to FIGS. 1 to 4, in the first embodiment and the second embodiment, the heat dissipating base 121a has a first surface S1 and a second surface S2 opposite to the first surface S1. The first surface S1 contacts the heat source H. The heat sink fins 121b and the fan 130, 130a are disposed on the second surface S2.

Since the airflow may not exit from the bottom of the centrifugal fan, the heat source H may be disposed on a position that an orthogonal projection A1 of the heat source H on the second surface S2 and an orthogonal projection A2 of the fan 130, 103a on the second surface S2 do not overlap.

The heat dissipating module 100 in FIG. 1, the fan 130 is disposed in the side of the first heat sink 120, and the orthogonal projection A1 of the heat source H in FIG. 3 is disposed on the upper right of the second surface S2.

The heat dissipating module 100a in FIG. 2, the fan 130a is disposed in the middle of the first heat sink 120a, and the projection A1 of the heat source H in FIG. 4 is disposed around the orthogonal projection A2 of the fan 130a.

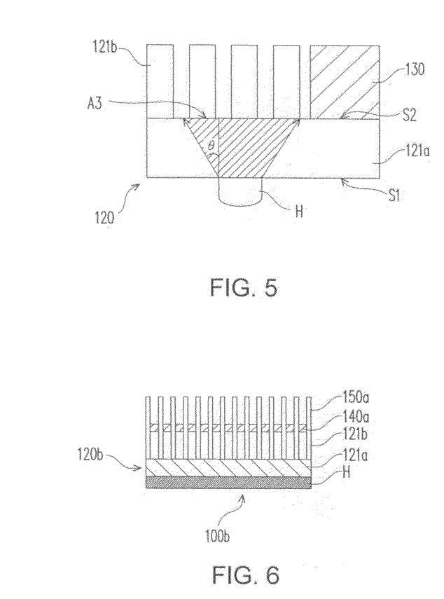

FIG. 5 is a partial enlargement schematic structural view of a heat source, a heat dissipating base, a first heat sink, and a fan in FIG. 1. Referring to FIGS. 1, 3, and 5, in the first embodiment, the heat source H may have a diffusion angle θ in the heat dissipating base 121a, so as to make an effective area A3 of the heat source H on the second surface S2 of the heat dissipating base 121a be larger than the orthogonal projection A1 of the heat source H on the second surface S2. Therefore, when the heat source H having a diffusion angle θ in the heat dissipating base 121a needs to consideration, the position of the heat source H on the heat dissipating base 121a may be far away the fan 130, 130a, and the effective area A3 of the heat source H and the orthogonal projection A2 of the fan 130, 130a on the second surface S2 do not overlap.

FIG. 6 is a schematic structural view of a heat dissipating module according to a third embodiment of the invention. In the third embodiment of the invention, the first heat sink 120b and the second heat sink 150a of the heat dissipating module 100b are integrally formed. In other words, the half bottom of one set of interval arranged heat sink fins 121b and the heat dissipating base 121a form the first heat sink 120b, the half top of one set of interval arranged heat sink fins 121b forms the second heat sink 150b. Moreover, the partition 140a divides the gap between the first heat sink 120b and second heat sink 150b.

In the embodiment of the invention, the material of the partition 140a is a heat insulation material, such as plastic. Therefore, the partition 140a may not transmit heat between the heat dissipating fins of the first heat sink 120b and the second heat sink 150a, and heat of the heat source H may quickly and directly transmit to the second heat sink 150a through the first heat sink 120b to dissipate heat.

In summary, the embodiment or the embodiments of the invention may have at least one of the following advantages, the heat dissipating module employs stacks of the multiple heat sinks and is capable of increasing heat exchange area and heat exchange time between the heat dissipating module and the airflow to improve the heat dissipation efficiency. Furthermore, the heat dissipating module may include the guiding housing and outlet guiding component to guide the flow direction of the airflow, and the heat dissipation efficiency is increased. In addition, the centrifugal fan may be disposed in the heat dissipating module to reduce the volume of the heat dissipating module.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A heat dissipating module adapted for transferring heat from a heat source, the heat dissipating module comprising:
a first heat sink, adapted to be connected to the heat source and having an outlet;
a fan, disposed adjacently to the first heat sink;
a second heat sink, connected to the first heat sink; and
a partition, disposed between the first heat sink and the second heat sink, the partition having an inlet, and the position of the inlet being corresponding to the position of the fan,
wherein an airflow driven by the fan is capable of flowing through the second heat sink, the inlet, and the first heat sink in sequence, and the airflow is capable of exiting from the outlet of the first heat sink.

2. The heat dissipating module as claimed in claim 1, wherein the second heat sink is connected to the first heat sink through the partition, and a material of the partition comprises a thermal conduction material.

3. The heat dissipating module as claimed in claim 2, wherein a material of the partition comprises a metal.

4. The heat dissipating module as claimed in claim 1, wherein the first heat sink and second heat sink are integrally formed, a gap between the first heat sink and second heat sink is divided by the partition, and a material of the partition comprises a heat insulation material.

5. The heat dissipating module as claimed in claim 4, wherein a material of the partition comprises a plastic.

6. The heat dissipating module as claimed in claim 1, wherein the fan is a centrifugal fan.

7. The heat dissipating module as claimed in claim 1, further comprising an outlet guiding component adjoining the outlet for changing a flow direction of the airflow exiting from the outlet.

8. The heat dissipating module as claimed in claim 1, further comprising a guiding housing disposed on one side of the second heat sink, so as to make the second heat sink be disposed between the guiding housing and the partition, the guiding housing, the second heat sink, and partition forming a channel area, and the channel area being communicated with the inlet.

9. The heat dissipating module as claimed in claim 1, wherein the first heat sink comprises a heat dissipating base and a plurality of heat sink fins, the heat dissipating base has a first surface and a second surface opposite to the first surface, the first surface contacts the heat source, the heat sink fins and the fan are disposed on the second surface, so as to make the heat sink fins and the heat source be disposed at two opposite sides of the heat dissipating base respectively, and make the fan and the heat source be disposed at the two opposite sides of the heat dissipating base respectively.

10. The heat dissipating module as claimed in claim 9, wherein an orthogonal projection of the heat source on the second surface and an orthogonal projection of the fan on the second surface do not overlap.

11. The heat dissipating module as claimed in claim 9, wherein the heat source has a diffusion angle, so as to make an effective area of the heat source on the second surface be larger than the orthogonal projection of the heat source on the second surface, and the effective area of the heat source and the orthogonal projection of the fan on the second surface do not overlap.

12. The heat dissipating module as claimed in claim 1, wherein the heat source is a light emitting diode.

13. The heat dissipating module as claimed in claim 1, wherein a flow direction of the airflow driven by the fan in the second sink and a flow direction of the airflow driven by the fan in the first sink are adverse.

14. An illuminance device, comprising:
a light source, capable of providing a light beam; and
a heat dissipating module comprising:
a first heat sink, connected to the light source and having an outlet;
a fan, disposed adjacently to the first heat sink;
a second heat sink, connected to the first heat sink; and
a partition, disposed between the first heat sink and the second heat sink, the partition having an inlet, and the position of the inlet being corresponding to the position of the fan,
wherein an airflow driven by the fan is capable of flowing through the second heat sink, the inlet, and the first heat sink in sequence, and the airflow is capable of exiting from the outlet of the first heat sink.

15. The illuminance device as claimed in claim 14, wherein the illuminance device is a road lamp.

16. The illuminance device as claimed in claim 14, wherein the second heat sink is connected to the first heat sink through the partition, and a material of the partition comprises a thermal conduction material.

17. The illuminance device as claimed in claim 14, wherein the first heat sink and second heat sink are integrally formed, a gap between the first heat sink and second heat sink is divided by the partition, and a material of the partition comprises a heat insulation material.

18. The illuminance device as claimed in claim 14, wherein the first heat sink comprises a heat dissipating base and a plurality of heat sink fins, the heat dissipating base has a first surface and a second surface opposite to the first surface, the first surface contacts the light source, the heat sink fins and the fan are disposed on the second surface, so as to make the heat sink fins and the light source be disposed at two opposite sides of the heat dissipating base respectively, and make the fan and the light source be disposed at the two opposite sides of the heat dissipating base respectively.

19. The illuminance device as claimed in claim 18, wherein an orthogonal projection of the light source on the second surface and an orthogonal projection of the fan on the second surface do not overlap.

20. The illuminance device as claimed in claim 18, wherein the light source has a diffusion angle, so as to make an effective area of the light source on the second surface be larger than the orthogonal projection of the light source on the second surface, and the effective area of the light source and the orthogonal projection of the fan on the second surface do not overlap.
